(19) United States
(12) Patent Application Publication
(10) Pub. No.: US 2010/0005033 A1
(43) Pub. Date: Jan. 7, 2010

(54) System and Method for In-Kind Rebalancing of Transactions

(76) Inventors: Robert BOYDA, Sherborn, MA (US); Paul T. KANE, Whitinsville, MA (US); Leo ZERILLI, Beverly, MA (US); John VRYSEN, Hopkinton, MA (US); Chris HURLEY, Dallas, TX (US); David P. CHOATE, Dallas, TX (US)

Correspondence Address: WILMERHALE/BOSTON, 60 STATE STREET, BOSTON, MA, 02109, US

(21) Appl. No.: 12/476,964

(22) Filed: Jun. 2, 2009

Related U.S. Application Data
(60) Provisional application No. 61/058,036, filed on Jun. 2, 2008.

(51) Int. Cl. G06Q 40/00

(52) U.S. Cl. 705/36 R; 705/37

(57) ABSTRACT

A system and method are described for an investor, such as a fund of funds, to advantageously perform portfolio rebalancing in a totally in-kind or combination in-kind/cash transaction that will at least minimize the transaction costs associated with rebalancing.

### RELATED APPLICATIONS

The present application claims priority to provisional application 61/058,036, filed Jun. 2, 2008.

### FIELD OF THE INVENTION

The present invention relates to systems and methods that are used in portfolio rebalancing to support an investment strategy. More specifically, the present invention relates to systems and methods for rebalancing portfolio holdings of fund of funds to meet investment strategy goals or merger of funds, or the transfer of assets between funds.

### BACKGROUND OF THE INVENTION

An important part of investing at any investor level, e.g., as an individual, an institution, or a fund, is to periodically rebalance an investment portfolio in order to maintain a preferred portfolio asset allocation to meet original investment goals or meet new investment goals. This may be accomplished by either resetting the portions of each asset class back to its original percentage or setting the portions of each asset class to new percentages to meet new investment goals.

In its simplest form, portfolio asset allocation determines the portfolio's risk/return characteristics. Over time, as different asset classes produce different returns, a portfolio's asset allocation changes. The rebalancing of the portfolio permits the original risk/return characteristics to be regained or new risk/return characteristics to be implemented. Portfolio rebalancing may be carried out automatically on a periodic basis, such as monthly, quarterly, bi-annually, or annually, or on a non-periodic, non-automatic basis.

A generic example of rebalancing would be that an investor had $500,000 to invest and made an asset allocation of 60% of that amount to be invested in stocks (either directly or through a stock fund) and 40% in bonds (either directly or through a bond fund). Accordingly, the investor would purchase $300,000 of a stock index fund and $200,000 of a bond index fund. If the investor found after six months that the bond index fund had gone up 4% and the stock index fund had gone down 9%, the resulting portfolio value would be reduced to $481,000. This also would mean that stocks (represented by the stock index fund) would now make up 57% of the portfolio instead of 60%, and bonds (represented by the bond index fund) would make up 43% instead of 40%. To rebalance the portfolio, the investor would effectively sell some bonds from the bond fund index and use these funds to further invest in the stock index fund to rebalance the portfolio holdings. With the portfolio value now being valued at $481,000, a 40% bond allocation would be $194,200. Since the current value of the bonds would be $208,000, the difference in amounts in the bond values for rebalancing purposes would be $15,600. Accordingly, a sufficient number of bonds from the bond index fund would be sold to redeem $15,600 from the bond index fund. This redeemed amount would be used to further invest in the stock index fund. Once this is accomplished, the investor's portfolio asset allocation targets would be regained.

As stated, an investor may abandon the original portfolio asset allocation and select a new one, for example, because of changed market conditions. In such cases, the investor would buy/sell funds that in turn would invest in bonds or stocks to achieve this new investment strategy.

An investor may not be an individual per se, but may be a “fund of funds.” A fund of funds would hold a portfolio of investments in other funds rather than investing directly in stocks, bonds, or other securities. For example, if the fund of funds is a mutual fund, it could invest in other mutual funds.

Management of fund of funds is typically by a fund advisor. This fund advisor would periodically review the fund's holdings and rebalance them to meet the investment strategy goals. Rebalancing of a fund of funds may be carried out on a periodic or nonperiodic basis by redeeming its interest in one or more underlying funds in which it is invested and reinvesting the redeemed proceeds in another mutual fund that may have or not have an affiliated relationship with the fund of funds. As used herein, an affiliated relationship of two or more funds would mean they are under common management.

The fund of funds would receive a cash redemption in a redemption part of the rebalancing transaction, and the redeemed cash would be used for the reinvestment in another, hopefully better performing fund or rebalancing the asset allocations, e.g., a certain percentage in a bond based mutual fund and a certain percentage in a stock based mutual fund. This is referred to as an all-cash rebalancing. When an all-cash rebalancing method is used, it has disadvantages.

Typically, the shares of each underlying fund of a fund of funds are offered to other investors. Accordingly, large cash purchases or redemptions can adversely affect any investor invested in such an underlying fund. These adverse affects can be in the form of (i) in the case of taxable products, the realization of taxable gains that might otherwise have been deferred or realized as long-term gains; (ii) the dilution of investment returns in favorable markets as a result of cash drag occasioned by large cash infusions that take time to be invested; (iii) the costs of maintaining a credit facility, if applicable, as an alternative to keeping cash on hand to satisfy large cash redemptions; and (iv) the transaction costs associated with liquidating securities or investing cash to satisfy the redemption or subscription in the underlying fund. All of these factors can arise whenever a fund of funds rebalances in cash only. For clarity, “cash drag” would be understood to be excess cash holdings by an underlying fund, either in order to satisfy large cash redemptions in the case of a redemption fund or the pending investments of such cash, typically within the Subscription Fund, while working on purchase orders over several days or weeks to avoid paying unattractive prices.

Rebalancing by the fund of funds may be triggered by the occurrence of certain events or under certain conditions. For example, it may occur when (i) the weighting of an underlying fund in the fund of fund's portfolio has exceeded tolerances prescribed for the fund of funds; (ii) an underlying fund in the fund of funds portfolio is underperforming and the fund advisor for the fund of funds decides to replace it with a better performing fund; (iii) the fund advisor makes an asset allocation decision that requires an adjustment of the holdings of the fund of funds; or (iv) an underlying fund in the fund of funds portfolio reorganizes or liquidates.

In order to overcome the disadvantages of conventional systems for rebalancing a fund of funds in all-cash transactions, the present invention provides a novel system and method of rebalancing in a totally in-kind or combination in-kind/cash transaction.

### SUMMARY OF THE INVENTION

The present invention is a system and method for a fund of funds to advantageously carry out rebalancing in a totally in-kind or combination in-kind/cash transaction. In a preferred embodiment of the present invention, a fund of funds (hereinafter a “First Tier Fund”) will select a rebalancing event time on a periodic or non-periodic basis, and at that event time will redeem the proceeds of the designated underlying fund, the Redemption Fund, totally in-kind, or partially in-kind and partially in cash. For purposes of describing the present invention, it is presuming for simplification only one Redemption Fund would be involved in the transaction; however, it is understood that the invention contemplates redemptions from one or more Redemption Funds simultaneously in carrying out the present invention.

The First Tier Fund preferably will obtain a target list for reinvestment with regard to a participating fund, the Subscription Fund, to meet the Subscription Fund's current or new investment strategy, objectives or investments (hereinafter the “target list”). For purposes of describing the present invention, it is presuming for simplification only one Subscription Fund would be involved in the transaction; however, it is understood that the present invention contemplates subscriptions into one or more Subscription Funds simultaneously in carrying out the present invention.

The First Tier Fund will compare the in-kind redemption from the Redemption Fund with the target list of the Subscription Fund. The comparison will be with respect to the particular securities holdings and their respective quantities. The First Tier Fund will then carry out transactions with other participating funds on an internal market first and then on the open market to conform, as best as possible, its holdings to those of the Subscription Fund's target list. These transactions, to conform the First Tier Fund's securities holdings to the target list, may result in some remaining cash.

After the First Tier Fund's holdings have been repositioned to conform to the Subscription Fund target list, the First Tier Fund will contribute the in-kind repositioned securities holdings and remaining cash to the Subscription Fund. This contribution will result in the First Tier Fund being invested in the Subscription Fund according to the target list, and the First Tier Fund will receive shares in the Subscription Fund in return.

The benefits of the system and method of the present invention include, but are not limited to, minimizing cash drag associated with the rebalancing transaction, in whole or in part inimizing the impact on the underlying funds (i.e., each of the Redemption Fund and the Subscription Fund), and minimizing the transaction costs associated with repositioning the redemption proceeds. Another benefit of the system and method of the present invention is that the transaction costs associated with a rebalancing transaction will be experienced, in-whole or in-part, by the First Tier Fund, rather than either of the underlying funds. Typically, underlying funds sell their shares to various types of investors, including First Tier Funds. In a cash rebalancing transaction, all investors in the underlying funds experience transactions costs and cash drag, but only some investors in the underlying fund are First Tier Funds that benefit from the rebalancing transaction. However, under the system and method of the present invention, to the extent that the First Tier Fund alone absorbs transactions costs associated with a rebalancing transaction, the other investors in the underlying funds will not experience those same transaction costs. The impact of shifting transaction costs to the First Tier Fund will be to isolate some or all of these costs in the fund that seeks to benefit from the rebalancing transaction. In this respect, the proposed system and method of the present invention may be viewed favorably to investors in the underlying funds.

The system and method of the present invention will be described in greater detail in the remainder of the specification referring to the drawings.

### BRIEF DESCRIPTION OF THE DRAWINGS

FIG. 1 shows a representative relationship of funds for rebalancing according to the system and method of the present invention.

FIG. 2 shows a representative diagram for the implementation of the system and method of the present invention.

FIG. 3 shows a representative table of the holdings of the First Tier Fund and Subscription Fund, including the target list marked with an asterisk, after redemption but before subscription.

FIG. 4 shows a representative table of the Subscription Fund target list shown marked with an asterisk and Subscription Fund holdings not marked with an asterisk before subscription with the NAV and external market prices.

FIG. 5 shows representative transactions for the repositioning the First Tier Fund to conform to the Subscription Fund target list.

FIG. 6 shows a representative in-kind repositioned First Tier Fund for contribution to the Subscription Fund.

### DETAILED DESCRIPTION OF THE DRAWINGS

The present invention is a system and method for a First Tier Fund to carry out in-kind rebalancing on a periodic or nonperiodic basis to meet investment goals. Preferably, the First Tier Fund, a fund of funds, will redeem the proceeds of a Redemption Fund, a designated Underlying Fund, and use those proceeds to reposition its holding according to a target list of a Subscription Fund, another Participating Fund. This repositioning is carried out through transactions according to predetermined preferences. After repositioning is complete, the First Tier Fund will contribute in-kind securities holdings and remaining cash to Subscription Fund for shares of the Subscription Fund.

For purposes of the present inventions, the following preferred definitions are provided:

“In-kind rebalancing” includes total in-kind rebalancing and the combination of in-kind/cash rebalancing.

“Underlying Fund” means a mutual fund in which a First Tier Fund invests.

“Participating Fund” is a mutual fund that can buy or sell interests in financial instruments of all types commonly referred to as “securities,” but that may include any kind of tradable financial instrument (hereinafter “securities”) and, as such, the fund may be (i) another First Tier Fund, a Standalone Fund, or an Underlying Fund in an internal market with the First Tier Fund that is rebalancing, or (ii) an Underlying Fund that is not in the internal market with the First Tier Fund that is rebalancing.

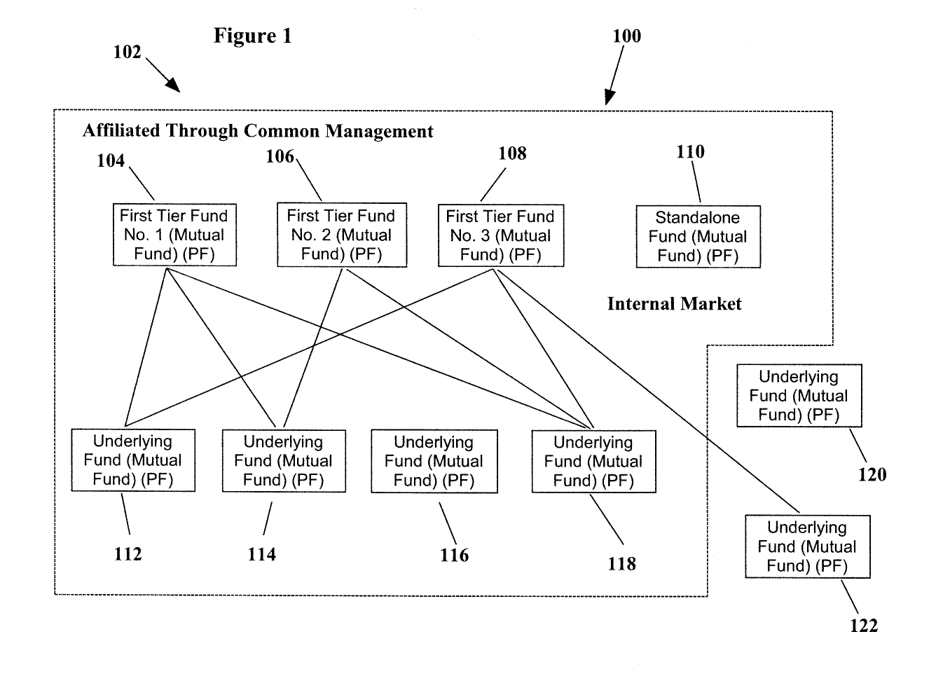

Referring to FIG. 1, generally at 100, the relationship between a First Tier Fund that is to be rebalanced, other First Tier Funds, a Standalone Fund, and Underlying Funds is shown. First Tier Fund No. 1 at 104 is shown within area 102 with other First Tier Funds, Standalone Fund 110 and Underlying Funds 112, 114, 116, and 118. The other First Tier Funds are First Tier Fund No. 2 at 106 and First Tier Fund No. 3 at 108. Underlying Funds 120 and 122 are shown outside area 102. Each of the funds referred to above may act as a Participating Fund and to indicate this, each includes the designation “(PF).”

The specific investing relationships shown in FIG. 1 will now be described. In FIG. 1, First Tier Fund No. 1 at 104 is invested in Underlying Funds 112, 114, and 118. First Tier Fund No. 2 at 106 is invested in Underlying Funds 114 and 118. First Tier Fund No. 3 at 108 is invested in Underlying Funds 112, 118, and 122. FIG. 1 does not show any investors in area 102 being invested in Underlying Fund 120. This Fund would be receiving investments from other investors (not shown). It is understood that each of the Underlying Funds may have a variety of investors among the affiliated funds and outside investors.

Preferably, each fund in area 102 is a mutual fund, but it is understood that each could be a different type of fund, such as an exchange traded fund (hereinafter an “ETF”), a hedge fund, a collective investment fund, or an insurance company separate account, and still be within the scope of the present invention. Further, each of the funds within area 102 represent funds under common management. As such, they form an internal market that permits them to carry out transactions among themselves without incurring normal market transaction costs.

Preferably, Underlying Funds 120 and 122 also are mutual funds. Underlying Fund 122 is not within area 102 but First Tier Fund No. 3 at 108 is shown invested in it. To the extent that First Tier Fund No. 1 at 104, First Tier Fund No. 2 at 106, or First Tier Fund No. 3 at 108 makes an investment in either Underlying Funds 120 or 122 and there has been no previous investment, it would likely not be an internal market transaction at internal market prices, but an external market transaction at external market prices.

The system and method of the present invention may be incorporated in a computer-based system and be within the scope of the present invention. According to a preferred embodiment of the present invention, a computer-based system would have access to electronically stored representations of the portfolio holdings of the First Tier Fund Nos. 1, 2, and 3 at 104, 106, and 108, respectively, Standalone Fund 110, and Underlying Funds 112, 114, 116, 118, 120, and 122, and be configured to implement the rebalancing method of the present invention.

The fund adviser who manages a First Tier Fund will determine on a periodic or nonperiodic basis when to carry out rebalancing of that First Tier Fund's holdings. This may also be a programmed event for the computer-based system that handles rebalancing.

Rebalancing may be effected on the occurrence of predetermined trigger events. For example, these trigger events may include, but are not be limited to (i) automatic rebalancing on a timed basis, such as every month, six months, annually, etc., (ii) an Underlying Fund's weighting in the First Tier Fund's portfolio exceeding tolerances prescribed for the First Tier Fund, (iii) an Underlying Fund underperforming and the decision to replace it with another Participating Fund with better performance, (iv) the First Tier Fund making an asset allocation decision that requires adjustment of its holdings, or (v) an Underlying Fund's reorganization or liquidation. It is understood that other events could trigger rebalancing and still be within the scope of the present invention.

In a preferred embodiment of the present invention, the Redemption Fund is an Underlying Fund of at least the First Tier Fund, and the Subscription Fund is a Participating Fund. It is understood that the Redemption Fund may be one of a plurality of Underlying Funds in which the First Tier Fund is invested (see FIG. 1), and the Subscription Fund, a Participating Fund, may be one or more funds in which the First Tier Fund may or may not be currently invested (see FIG. 1).

The present invention may be implemented based on objective criteria to determine when it would be appropriate to carry out in-kind rebalancing instead of cash only rebalancing. This criteria includes, but is not limited to (i) the percentage of the assets relative to the Underlying Fund, i.e., if the percentage is deemed to be small (based upon objective criteria that may be established), then all-cash rebalancing may be selected; (ii) the liquidity of holdings in the Underlying Fund, i.e., if the holdings are very illiquid, then all-cash rebalancing may be selected; (iii) the cash flow expectations of the First Tier Fund and Underlying Fund; or (iv) the costs of paying the redemption in cash by borrowing from the Redemption Fund's committed credit facility. Other factors the First Tier Fund may consider before implementing in-kind rebalancing include, but are not limited to (v) the ability to satisfy targeted portfolio objectives with securities available through the in-kind redemption from the Underlying Fund; and (vi) even if the First Tier Fund were to place a redemption order in excess of the predetermined percentage mentioned above at (i), the incoming cash flow into the Underlying Fund from other sources may cause the net redemptions from all investors to be equal to or less than a predetermined percentage. However, it is understood that the First Tier Fund may carry out in-kind rebalancing as a default condition rather than being based on the occurrence of certain events or considering any specific criteria.

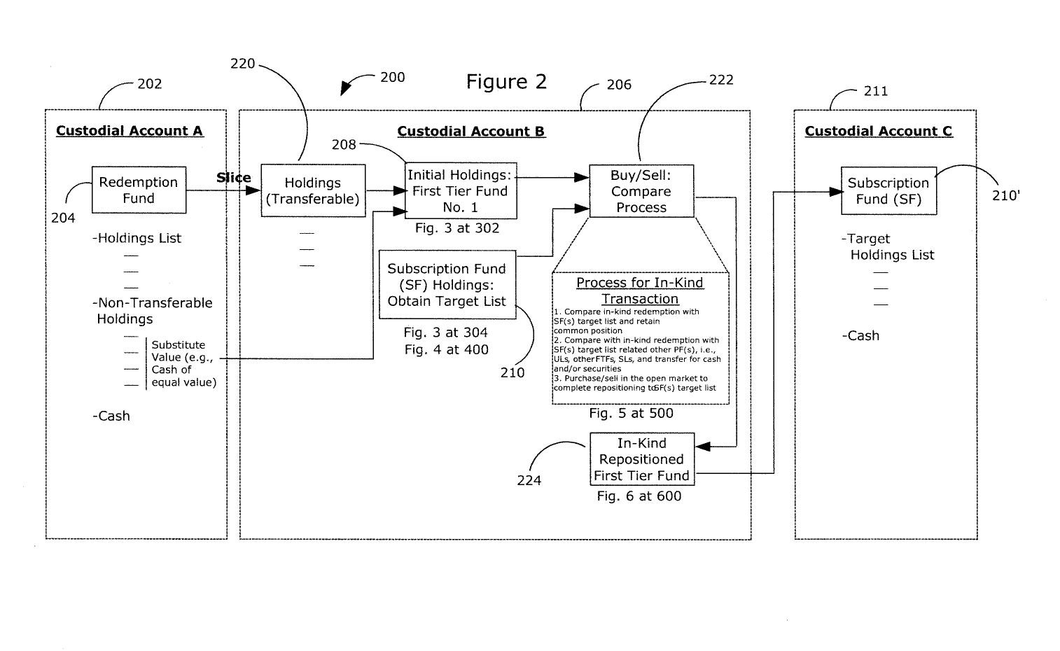

The system and method of the present invention will be now described in detail referring to FIGS. 2-6. An exemplary rebalancing with respect to First Tier Fund No. 1 at 104 will be used to describe the present invention; however, it is understood that other funds may be rebalanced according to the present invention and still be within the scope of the present invention.

Referring to FIG. 2, generally at 200, a representative diagram showing an implementation of the system and method of the present invention is provided. For purposes of description, First Tier Fund No. 1 at 208 and Subscription Fund target list 210 (used for in-kind repositioning) are shown under Custodial Account B 206. Redemption Fund 204, an Underlying Fund, is shown under Custodial Account A 202. Subscription Fund 210′, a Participating Fund from which the target list is obtained, is shown under Custodial Account C 211. The Subscription Fund is marked as 210′ under Custodial Account C 211 because it represents the repositioned form of First Tier Fund No. 1 at 208 based on the in-kind and cash contribution following subscription. It is understood that the Participating Fund(s) from which the Subscription Fund target list is obtained may include any number of other securities holdings and still be within the scope of present invention.

Generally, it is deemed appropriate to use the in-kind rebalancing system and method of the present invention if it may be advantageous to the Underlying Fund from which there will be a redemption, the Participating Fund that will be the Subscription Fund to which First Tier Fund No. 1 will make its contribution after subscription, or both the Underlying (Redemption) Fund and Subscription Fund. It is understood it may be advantageous to the First Tier Fund performing the rebalancing transaction.

When the present invention is implemented, the Underlying Fund will pay redemption proceeds to First Tier Fund No. 1 (i) wholly in-kind or (ii) partially in-kind and partially in cash. Typically, the in-kind redemption proceeds transferred from the Underlying Fund, Redemption Fund 204, to First Tier Fund No. 1 at 208 represent a pro rata slice of the Underlying Fund's portfolio holdings, excluding restricted securities, bilateral agreements, odd lots, and other assets permitted to be excluded from such pro rata slice in accordance with the applicable regulatory rules of the jurisdiction in which rebalancing is taking place. Cash and other acceptable assets of equal value will be substituted for the excluded assets. The substituted cash or other acceptable assets will be added to the in-kind redemption proceeds, so that the total value of the redemption proceeds in-kind and cash will equal the net value of the shares being redeemed by First Tier Fund No. 1 at 208. This is shown graphically in FIG. 2 at 202 and 206.

Again referring to FIG. 2, as stated, if in-kind rebalancing according to the system and method of the present invention is implemented on a periodic or nonperiodic basis, an Underlying Fund will be selected for redemption. This selection may be based on at least one of the previously described trigger events or conditions. According to the redemption method of the present invention, the portfolio holdings of Redemption Fund 204 will be reviewed. As shown at 202, these holdings include a list of securities that can be in-kind redeemed, “Holdings List,” and “Not Transferable Holdings” and “Cash.” The pro rata ownership of Redemption Fund 204 by First Tier Fund No. 1 at 208 will be based on First Tier Fund No. 1's share of the fund. For example, if First Tier Fund No. 1 at 208 owned a 1% share of Redemption Fund 204 and Reduction Fund 204 had holdings of 1,000,000 shares of security A, 2,000,000 shares of security B, and 3,000,000 shares of security C, then the First Tier Fund No. 1's redeemed in-kind pro rata slice of these securities would be 10,000 shares of security A, 20,000 shares of security B, and 30,000 shares of security C.

With regard to nontransferable holdings of Redemption Fund 204, a substitute, such as the cash equivalent of the 1% value of these holdings, will be transferred to First Tier Fund No. 1 at 208 along with the in-kind transferable holdings. Finally, the 1% value of any cash held by the Redemption Fund will also be transferred to First Tier Fund No. 1 at 208 at redemption time.

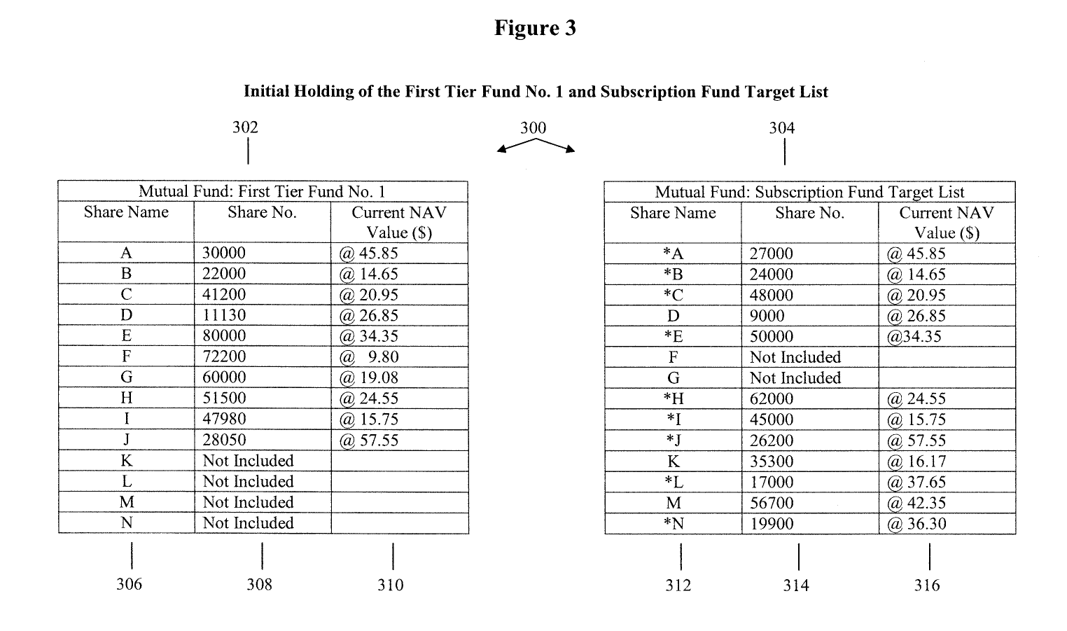

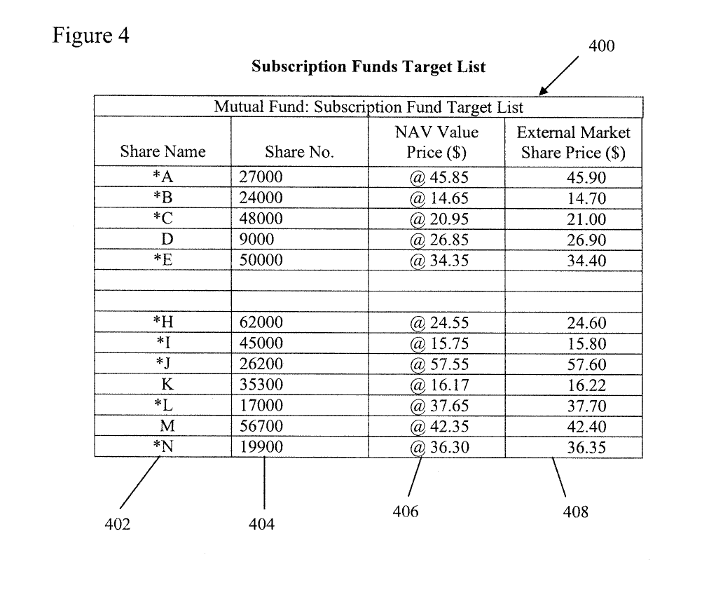

After making the redemption from Redemption Fund 204 that has been just described from one or a plurality of Underlying Funds that form Redemption Fund 204, First Tier Fund No. 1 at 208 shown at Custodial Account B will obtain a Subscription Fund target list 210 of securities. This target list is the preferred investment goal for First Tier Fund No. 1 at subscription at the end of the rebalancing process of the present invention. The Subscription Fund target list will be described with regard to FIGS. 3 and 4.

Referring to FIG. 3, generally at 300, a listing of the portfolio holdings of First Tier Fund No. 1 at 208 is shown at 302 and Subscription Fund target list 210 is shown at 304. The representations in FIG. 3 are after redemption and before subscription. In FIG. 3 at 302, column 1 at 306 lists the securities holdings of First Tier Fund 208; column 2 at 308 shows the number of shares held by First Tier Fund 208 after redemption; and column 3 at 310 shows the current market or fair value for such securities determined in accordance with the fund's valuation methodology under applicable laws and regulations when determining the fund's net asset value per share (the value used in calculating the fund's net asset value (“NAV”) and hereinafter the “NAV Value”) for the shares of the securities holdings in First Tier Fund No. 1 at 208. Also shown in 302 are the portfolio holdings of First Tier Fund No. 1 at 208 that do not match with the Subscription Fund target list. In FIG. 3 at 304, column 1 at 312 lists securities holdings and the target list of Subscription Fund 210; column 2 at 314 shows the number of shares currently held by, or make up target list 210 of the Subscription Fund; and column 3 at 316 shows the current NAV Values for securities listed in column 1 at 312. The target list securities are marked with an asterisk in column 1 at 312.

For each security listed at 306 for First Tier Fund No. 1 at 208, the number of shares and the current NAV Values are shown at 308 and 310, respectively. Summarily, for Subscription Fund target list 210 and securities holdings of the Subscription Fund for each security listed at 312, the number of shares and the current NAV Values are shown at 314 and 316, respectively. It is noted in FIG. 3 that First Tier Fund No. 1 at 208 includes securities A-J; Subscription Fund target list 210 includes securities A-C, E, H-J, L and N; and the securities holdings of the Subscription Fund (marked with asterisk) include securities D, K, and M. This will mean that the only matching securities on the two lists for rebalancing transaction purposes are securities A-E and H-J.

The pricing of shares of securities A-J of First Tier Fund No. 1 at 208 shown at 310 will be based on a predetermined valuation methodology. For example, it could be based on the last sale price for each security listed on a predetermined market, such as the NYSE, NASDAQ, or other securities trading exchange. The pricing of shares of securities A-E and H-N associated with Subscription Fund target list 210 and Subscription Fund securities holdings also will be based on a predetermined valuation methodology. Preferably, the methodology used for pricing the shares associated with the Subscription Fund and the Subscription Fund target list 210 will be substantially similar to the one used for pricing the shares of First Tier Fund No. 1 at 208, so that the prices will be the same for matching securities. However, it is understood that the methodologies and resulting value of shares on the two lists may be different and still be within the scope of the present invention. It is also understood that the share value of securities may be different based on the timing of the pricing of the shares associated with the Subscription Fund on the redemption date compared to when First Tier Fund No. 1 shares were priced.

As previously stated, the holdings of First Tier Fund No. 1 at 208 must be repositioned based on Subscription Fund target list 210. The repositioning that is to take place will be to reposition the individual securities holdings of First Tier Fund No. 1 at 208 as closely as practicable to Subscription Fund target list 210.

Referring to FIG. 4, generally at 400, Subscription Fund target list 210 and Subscription Fund securities holdings are shown. As stated, Subscription Fund target list 210 includes securities A-C, E, H-J, L and N, and the securities holdings of the Subscription Fund, which are not marked with an asterisk, include securities D, K, and M.

In FIG. 4, column 1 at 402 shows the Subscription Fund target list of securities holdings marked with an asterisk for repositioning the redeemed proceeds of First Tier Fund No. 1 at 208; column 2 at 404 shows the number of shares of the securities holdings listed in column 1 at 402; column 3 at 406 shows the internal market prices for the shares of securities holdings listed in column 1 at 402; and column 4 at 408 shows the external market share prices for the securities holdings listed in column 1 at 402.

For purposes of the present invention, the following preferred definitions of the terms “internal market price” and “external market price” are provided:

“Internal market price” refers to a determinable price for a security, such as the last sale price of that security on its principal exchange, without any commission or spread of the type charged by an intermediary (typically a broker or dealer) that is typically added to such price. Internal market price does not presume purchase or sale through an intermediary that charges a commission spread or similar transaction charge.

“External market price” refers to a determinable price for a security, such as the last sale price of that security on its principal exchange, plus a commission, spread or similar transaction charges charged by a broker-dealer or other financial intermediary. External market price presumes purchase or sale through an intermediary that charges a commission, spread, or similar transaction charge.

As stated, the target list of the Subscription Fund has the securities marked with an asterisk, namely securities A, B, C, E, H, I, J, L, and N. The target list is the desired new investment portfolio for First Tier Fund No. 1. To obtain the target list, preferably, there would be a review of the current holdings of the Subscription Fund on the redemption date and a determination of the securities in-kind to be traded for investment in the Subscription Fund. The target list can be based on market information, market trends, or other objective or subjective criteria and still be within the scope of the present invention.

Preferably, a target list will be determined on or before the NAV Values are set for the Subscription Fund on the redemption date. Also preferably, once the target list is set and priced, the target list will be “locked down” and will not change during the rebalancing transaction. However, it is understood that target list may change even when the list is locked down if there is a material change in circumstances, such as (i) in the relevant markets in which a security is being traded, (ii) with respect to the issuer of the relevant security, or (iii) in the price of relevant security.

Preferably, the internal market price is the same for First Tier Fund No. 1 at 208 and Subscription Fund target list. At transaction time, rebalancing may be performed by trades on the internal market, and buy/sell transactions on the internal market and external market. The trading prices for purposes of in-kind rebalancing will be the current market price for the particular transaction for that security on the market/exchange on which it is traded, preferably based upon a last buy/sell price, or a price supplied by a pricing service derived from buy/sell prices or other methods of valuation customary in the financial services industry.

The external market price typically will differ from (but may be the same as) the internal market price. The typical difference between the internal market price and external market price will be the additional fees and costs associated with any commissions, spread, or similar transaction costs or charges charged by a broker-dealer or other financial intermediary. For example, with regard to security A, the internal market price is $45.85 per share, while the external market price inclusive of commissions to execute the securities transaction is $45.90 per share (reflecting a presumed $0.05 per share commission). With regard to security B, the internal market price is $14.65 per share, while the external market price inclusive of commission on the transaction is $14.70 per share. It is understood that the $0.05 per share commission is only exemplary. The commission may be more or less than $0.05 per share and still be within the scope of the present invention. A fee other than a commission may be charged by an intermediary and still be within the scope of the present invention. For example, the price of the security may incorporate a spread or transactions cost.

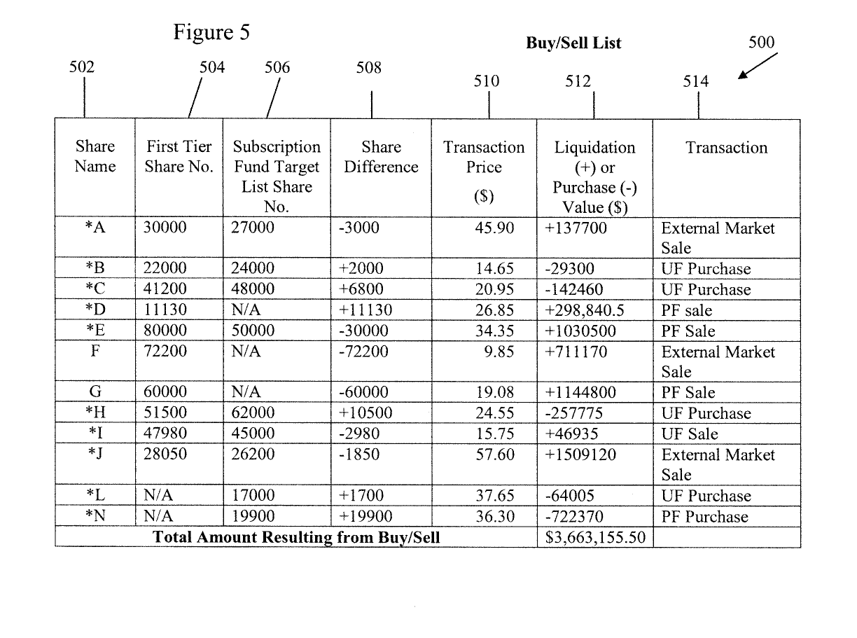

Once target list 210 is obtained, it will be compared at 222 (FIG. 2) to First Tier Fund's in-kind holdings that were redeemed from Redemption Fund 204. To the extent that the in-kind redemption holdings of First Tier Fund No. 1 at 208 match (share type and quantity) those on Subscription Fund target list 210, these holdings will be retained. To the extent there is more or less than a matching quantity of a particular security in First Tier Fund No. 1's holdings, First Tier Fund No. 1 must trade for, purchase, or sell securities to match its holding to the Subscription Fund target list. More specifically, following obtaining the Subscription Fund target list and determining what should be retained by First Tier Fund No. 1, the internal market, and the external market will be used to complete rebalancing to reposition First Tier Fund No. 1. This will be described referring to FIG. 5.

Referring to FIG. 5, generally at 500, an exemplary buy/sell list is shown for repositioning First Tier Fund 208 to Subscription Fund target list 210 (FIG. 4). In FIG. 5, column 1 at 502 lists the securities holdings of First Tier Fund No. 1 and Subscription Fund target list; column 2 at 504 shows the number of shares held by First Tier Fund 208 after redemption; column 3 at 506 shows the number of shares on Subscription Fund target list that are to be matched by the First Tier Fund No. 1 for repositioning; column 4 at 508 shows the number difference between First Tier Fund No. 1 securities holdings and the Subscription Fund target list for purposes of repositioning the First Tier Fund No. 1; column 5 at 510 shows the transaction prices for repositioning the First Tier Fund; column 6 at 512 shows the liquidation (+) or purchased (−) values of the transactions for repositioning First Tier Fund 208; and column 7 shows where the transaction was performed.

Again referring to FIG. 5, transactions to trade securities to reposition First Tier Fund 208 to Subscription Fund target list 210 can be transactions on the internal market at internal market prices and the external market at the external market prices. The order of preference for carrying out repositioning transactions is the following:

First preference: compare the redeemed portfolio of First Tier Fund No. 1 with the Subscription Fund target list and retain common positions.

Second preference: transactions with another Participating Fund seeking to buy/sell the security pursuant to a cross-trade between accounts at the internal market price.

Third preference: transactions on the external market, which includes the markets and/or exchanges on which the security at interest is normally traded.

The rebalancing transactions shown in FIG. 5 will now be discussed. Security A will involve retaining 27,000 shares and the sale of 3000 shares. Since the security, for example, is not included in the portfolio holdings or target list of other Participating Funds, which includes Underlying Funds, it must be sold on the external market at the external market price of $45.90.

Security B will involve retaining 22,000 shares and the purchase of 2000 shares. Since there are shares, for example, available for purchase on the internal market from an Underlying Fund to First Tier Fund No. 1, the 2,000 shares will have a transaction price of $14.65, which is the internal market price.

Security C will involve retaining 41,200 shares and the purchase of 6800 shares. Since there are shares, for example, available for purchase on the internal market from an Underlying Fund to First Tier Fund No. 1, the 6800 shares will have a transaction price of $20.95, which is the internal market price.

Security D is not on the Subscription Fund target list, therefore, it is not intended to be included in the repositioned First Tier Fund No. 1, so it will be sold. Since this security, for example, can be sold to a Participating Fund, e.g. Standalone Fund 110, the 11,130 shares will be sold at the internal market price of $26.85.

Security E will involve retaining 50,000 shares and the sale of 30,000 shares. Since 30,000 shares, for example, can be sold on the internal market to a Participating Fund, e.g. First Tier Fund No. 2 at 106, the 30,000 shares will have a transaction price of $34.35, which is the internal market price.

Security F is directed to 72,200 shares held by the First Tier Fund but is not listed on the Subscription Fund target list. Since the security, for example, is not included in the portfolio holdings or target list of other Participating Funds, which includes Underlying Funds, it must be sold on the external market at the external market price of $9.85.

Security G is directed to 60,000 shares held by First Tier Fund No. 1 but is not listed on the Subscription Fund target list. Since the security, for example, can be sold on the internal market to a Participating Fund, it would be sold at the internal market price of $19.08.

Security H will involve retaining 51,500 shares and the purchase of 10,500 shares. Since there are shares, for example, available for purchase on the internal market from an Underlying Fund to First Tier Fund No. 1, the 10,500 shares will have a transaction price of $24.55, which is the internal market price.

Security I will involve retaining 45,000 shares and the sale of 2980 shares. Since 2980 shares, for example, can be sold on the internal market to an Underlying Fund of the First Tier Fund, the 2980 shares will have a transaction price of $15.75, which is the internal market price.

Security J will involve retaining 26,200 shares and the sale of 1850 shares. Since the security, for example, is not included in the portfolio holdings of other Participating Funds, which includes Underlying Funds or in such funds' target lists, it must be sold on the external market at the external market price of $57.60.

Security L is directed to 17,000 shares included on the Subscription Fund target list but Security L is not a holding of First Tier Fund No. 1. Since the security, for example, can be purchased on the internal market from an Underlying Fund, it would be purchased at the internal market price of $37.65.

Security N is directed to 19,900 shares included on the Subscription Fund target list but Security N is not a holding of First Tier Fund No. 1. Since the security, for example, can be purchased on the internal market from a Participating Fund, including an Underlying Fund, it would be purchased at the internal market price of $37.30.

At the completion of the transactions in FIG. 5, there may be remaining cash. As shown in FIG. 5, at the completion of the series of transactions, there is remaining cash in the amount of $3,663,155.50.

It is understood that the repositioning transaction that have been described as buy and sell transactions may also be carried out in-whole or in-part in trading transactions involving swaps of securities of equal value and still be within the scope of the present invention. For, example the liquidation of Security D may be a trade for shares of a desired security where the trade value would be equal for both trading parties.

Preferably, the transactions according to the present invention will be performed as much as possible in-kind and using the internal market. This will at least minimize transaction costs by not requiring external market transaction costs.

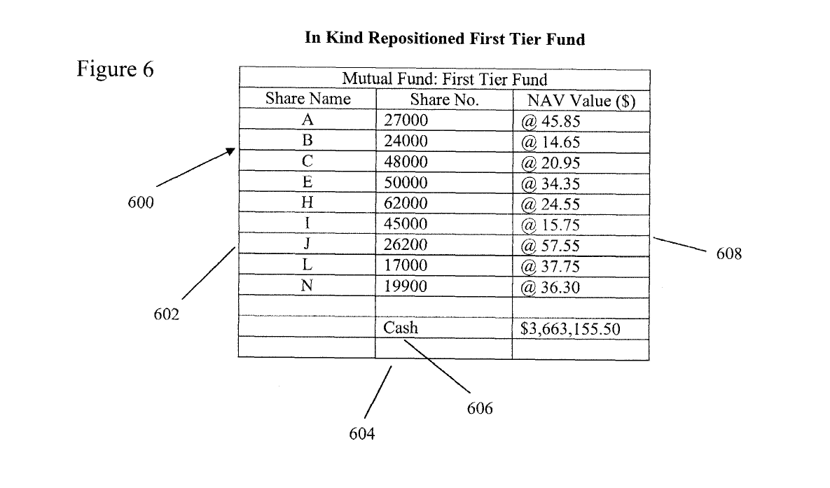

After completion of the rebalancing transactions, First Tier Fund No. 1 at 208 would have its holdings in-kind repositioned at 224 as closely as practicable to Subscription Fund target list 210. The repositioned in-kind holdings of First Tier Fund No. 1 at 208 and remaining cash are shown in FIG. 6.

Referring to FIG. 6, generally at 600, the in-kind repositioned First Tier Fund No. 1 at 208 is shown. In FIG. 6, column 1 at 602 shows the listing of securities holdings in the in-kind repositioned First Tier Fund No. 1; column 2 at 604 shows a number of shares for the securities holdings in the in-kind repositioned First Tier Fund No. 1; and column 3 at 606 shows a listing of the NAV Values for the securities holdings in the in-kind repositioned First Tier Fund No. 1. Further, at 606 in FIG. 6, the remaining cash from the buy/sell transactions in the amount of $3,663,155.50 is shown. First Tier Fund 208 is contributed in-kind to the Subscription Fund 210′ weighted to the target list, together with the remaining cash in exchange for shares in the Subscription Fund 210′ having equivalent value calculated in accordance with First Tier Fund No. 1's and Subscription Fund's predetermined valuation methodology. For purposes of example only, the prices shown are the transaction prices; it being understood that the prices may be different based on a predetermined valuation methodology and still be within the scope of the present invention. Following this, the subscription portion of the rebalancing is complete, as is the rebalancing process.

When the repositioned First Tier Fund at 244 is contributed to Subscription Fund 210′ under Custodial Account 211 (FIG. 2) (the subscription), First Tier Fund No. 1 will be given either (i) shares issued by the Subscription Fund 210′ based on the First Tier Fund's contribution, in the case of a Subscription Fund that issues shares of stock or beneficial interest, such as a corporation or business trust, or (ii) an ownership interest in securities holdings held by Subscription Fund based on the First Tier Fund's contribution in the case of a Subscription Fund, such as a partnership, that issues percentage participation in the capital of such Subscription Fund 210′.

To reduce the effect of market volatility, preferably, the time period from redemption through portfolio rebalancing and reinvestment in the Subscription Fund will be as short as possible, but may be extended over a period of time if deemed appropriate in order for the First Tier Fund to dispose of or acquire securities in order to better match the target list at the lowest practicable transactions cost and market impact typically associated with trading in securities.

In-kind rebalancing, according to the present invention, provides several advantages. These advantages include, but are not limited to, minimizing the impact of cash redemptions and cash subscriptions on Underlying Funds; maximizing cross trading opportunities among Participating Funds by trading on the internal market (thereby avoiding transactions costs and market impact); minimizing the performance drag associated with cash positions within Participating Funds and First Tier Fund No. 1; minimizing costs relative to repositioning holdings in the First Tier Fund No. 1 if a transaction must be executed in the market by minimizing commission costs, market impact, and opportunity costs; and maximizing tax efficiency and fairness to the Underlying (Redemption) Fund and its shareholders by avoiding a realization of tax gains occasioned by the sale of securities by the Redemption Fund in order to pay the First Tier Fund's redemption in cash.

It is also understood by one skilled in the art that the present invention also may be used in “merger” transactions and still be within the scope of the present invention. In a “merger transaction,” all the assets of a first fund, which would be in the place of the Redemption Fund, will be combined with the assets of a second fund, which would be in the place of the Subscription Fund. At the conclusion of the merger transaction, shareholders of the first fund would become shareholders of the second fund, and the first fund would dissolve. In the merger transaction, the first fund would rebalance its securities to match the target list of the second fund according the method of the present invention, except that the “merger transaction” may or may not involve the participation of a Top Tier Fund; that is, in a “merger” transaction, a first fund may transfer its assets directly to the second fund. As used herein the term “merger” is understood to refer to a merger or consolidation of two or more funds into one fund, or the purchase, sale or transfer of all or substantially all of the assets of a fund by another fund.

It would also be understood by a person of ordinary skill in the art that the present invention may be used for the in-kind transfer of the securities holdings (assets) of a first fund to a second fund and still be within the scope of the present invention. It is further understood that assets according to the present invention may be securities or other assets, e.g., real estate, commodities, and still be within the scope of the present invention for purposes of in-kind transfers.

The terms and expressions that are used herein are meant for description, not limitation, it being recognized that there may be minor changes or modifications that must take place and be within the scope of the present invention.

1. A computer-implemented method for rebalancing a portfolio of interests in securities holdings held by an investor to meet predetermined or changing investment goals, comprising the steps of:
(A) selecting a first security holding entity in which the investor has invested for redeeming at least partially in-kind securities holdings based on the investor's investment in the securities holdings of such first security holding entity for reinvestment in at least securities holdings of a second security holding entity;
(B) redeeming at least partially in-kind securities holdings held by the first security holding entity according to the investor's pro rata ownership share of such securities holdings based on the investor's investment in the securities holdings of such first security holding entity (redemption proceeds);
(C) selecting the second security holding entity in which to reinvest redemption proceeds and obtaining a target list for the securities holdings intended to be held by the second security holding entity in which to reinvest;
(D) comparing the in-kind redemption proceeds with the target list of securities holdings for the second security holding entity for matching securities quantities and performing transactions to substantially reposition securities holdings of the investor to the securities holdings on the target list of the second security holding entity according to predetermined transaction preferences; and
(E) the investor contributing to the second security holding entity the repositioned securities holdings of the investor and remaining transferable assets after completion of the transactions at step (1)(D), and the second security holding entity transferring to the investor the investor's pro rata ownership interest in the second security holding entity based on the investor's contribution.

2. The method as recited in claim 1, wherein redeeming at step (1)(B) includes redeeming the securities holdings held by the first security holding entity totally in-kind.

3. The method as recited in claim 1, wherein redeeming at step (1)(B) includes redeeming the securities holdings held by the first security holding entity according to the following:
(A) redeeming in-kind, in-kind transferable securities holdings,
(B) converting nontransferable in-kind securities holdings to transferable assets and redeeming the converted nontransferable assets, and
(C) redeeming other transferable assets other than the converted nontransferable assets at step (3)(B).

4. The method as recited in claim 3, wherein transferable assets include cash.

5. The method as recited in claim 4, wherein a total value of the redemption proceeds are substantially equal to the investor's pro rata ownership share of the securities holdings of the first security holding entity based on the investor's investment in the securities holdings of such first security holding entity.

6. The method as recited in claim 1, wherein investor includes a fund of funds.

7. The method as recited in claim 6, wherein the fund of funds includes a mutual fund and the second security holding entity includes a mutual fund.

8. The method as recited in claim 7, wherein selecting a second security holding entity includes selecting an affiliated entity that is commonly managed with the investor.

9. The method as recited in claim 8, wherein pricing for the transactions according to step (1)(D) includes pricing according to a predetermined pricing methodology.

10. The method as recited in claim 9, wherein pricing for the transactions according to step (1)(D) with an affiliated entity includes selecting pricing according to a predetermined market at a predetermined time.

11. The method as recited in claim 10, wherein pricing for the transactions according to step (1)(D) with a nonaffiliated entity includes pricing according to a external market price in a market in which such a securities holding is traded and transaction costs.

12. The method as recited in claim 1, wherein the investor's pro rata ownership interest in the second security holding entity includes a pro rata share of shares issued by the second security holding entity when the second security holding entity issues shares of beneficial interest.

13. The method as recited in claim 1, wherein the investor's ownership interest in the second security holding entity includes a pro rata share in the securities holdings held by the second security holding entity based on the investor's contribution when the second security holding entity issues percentage participation in capital of such second security holding entity.

14. The method as recited in claim 11, wherein transaction preferences include:
(A) a first preference to perform transactions with entities in which the investor has made investments at the time of rebalancing,
(B) a second preference to perform transactions with affiliated entities, and
(C) a third preference to perform transactions with nonaffiliated entities.

15. A computer-implemented method for a fund of funds mutual fund (FOF mutual fund) to rebalance its portfolio of interests in securities holdings held by an underlying mutual fund in which FOF mutual fund has invested to meet predetermined or changing investment goals, comprising the steps of:
(A) selecting an underlying mutual fund (redemption mutual fund) in which the FOF mutual fund has invested for redeeming at least partially in-kind securities holdings based on the FOF mutual fund's investment in the securities holdings of such redemption mutual fund for reinvestment in securities holdings of an affiliated mutual fund (subscription mutual fund) that is commonly managed with the FOF mutual fund;
(B) redeeming at least partially in-kind securities holdings held by the redemption mutual fund according to the FOF mutual fund's pro rata ownership share of such securities holdings based on the FOF mutual fund's investment in the securities holdings of such redemption mutual fund (redemption proceeds);
(C) selecting the subscription mutual fund to reinvest redemption proceeds and obtaining a target list for the securities holdings intended to be held by the subscription mutual fund in which to reinvest;
(D) comparing the in-kind redemption proceeds with the target list of securities holdings of the subscription mutual fund for matching securities quantities and performing transactions to substantially reposition securities holdings of the FOF mutual fund to the securities holdings on the target list of the subscription mutual fund according to predetermined transaction preferences; and
(E) the FOF mutual fund contributing to the subscription mutual fund the repositioned securities holdings of the FOF mutual fund and remaining transferable assets after completion of the transactions at step (15)(D), and the subscription mutual fund transferring to the FOF mutual fund the FOF mutual fund's pro rata ownership share of the subscription mutual fund based on the FOF mutual fund's contribution.

16. The method as recited in claim 15, wherein redeeming at step (15)(B) includes redeeming the securities holdings held by the redemption mutual fund totally in-kind.

17. The method as recited in claim 15, wherein redeeming at step (15)(B) includes redeeming the securities holdings held by the redemption mutual fund according to the following:
(A) redeeming in-kind, in-kind transferable securities holdings,
(B) converting nontransferable in-kind securities holdings to transferable assets and redeeming the converted nontransferable assets, and
(C) redeeming other transferable assets other than the converted nontransferable assets at step (17)(B).

18. The method as recited in claim 17, wherein transferable assets include cash.

19. The method as recited in claim 18, wherein a total value of the redemption proceeds are substantially equal to the FOF mutual fund's pro rata ownership share of the securities holdings of the redemption mutual fund based on the FOF mutual fund's investment in the securities holdings of such redemption mutual fund.

20. The method as recited in claim 15, wherein pricing for the transactions according to step (15)(D) includes pricing according to a predetermined pricing methodology.

21. The method as recited in claim 20, wherein pricing for the transactions according to step (15)(D) with an affiliated mutual fund includes selecting pricing according to a predetermined market at a predetermined time.

22. The method as recited in claim 21, wherein pricing for the transactions according to step (15)(D) with a nonaffiliated mutual fund includes pricing according to a external market price in a market in which such a securities holding is traded.

23. The method as recited in claim 22, wherein transaction preferences include:
(A) a first preference to perform transactions with mutual funds in which the FOF mutual fund has made investments at the time of rebalancing,
(B) a second preference to perform transactions with affiliated mutual funds, and
(C) a third preference to perform transactions with nonaffiliated mutual funds.

24. A computer-implemented method for merging first and second mutual funds, comprising the steps of:
(A) selecting the first mutual fund that will be merged into the second mutual fund;
(B) redeeming at least partially in-kind securities holdings held by the first mutual fund according to the first mutual fund's pro rata ownership shares of securities in one or a plurality of underlying mutual funds based on the first mutual fund's investment in such one or plurality of underlying mutual funds (merging proceeds);
(C) comparing the in-kind merging proceeds with a target list of securities holdings of the second mutual fund for matching securities quantities and performing transactions to substantially reposition securities holdings of the first mutual fund to the securities holdings on the target list of the second mutual fund according to predetermined transaction preferences; and
(D) the first mutual fund contributing to the second mutual fund the repositioned securities holdings of the first mutual fund and remaining transferable assets after completion of the transactions at step (24)(C), and the second mutual fund transferring to the first mutual fund the first mutual fund's pro rata ownership share of the second mutual fund based on the first mutual fund's contribution.

25. The method as recited in claim 24, wherein redeeming at step (24)(B) includes redeeming the securities holdings held by the first mutual fund in one or plurality of underlying mutual funds totally in-kind.

26. The method as recited in claim 15, wherein redeeming at step (24)(B) includes redeeming the securities holdings held by the first mutual fund in one or plurality mutual funds according to the following:
(A) redeeming in-kind, in-kind transferable securities holdings,
(B) converting nontransferable in-kind securities holdings to transferable assets and redeeming the converted nontransferable assets, and
(C) redeeming other transferable assets other than the converted nontransferable assets at step (26)(B).

27. The method as recited in claim 26, wherein transferable assets include cash.

28. The method as recited in claim 27, wherein a total value of the merging proceeds are substantially equal to the first mutual fund's pro rata ownership share of the securities holdings of the one or plurality of mutual funds based on the first mutual fund's investment in the securities holdings of such one or plurality of mutual funds.

29. The method as recited in claim 24, wherein pricing for the transactions according to step (24)(C) includes pricing according to a predetermined pricing methodology.

30. The method as recited in claim 29, wherein pricing for the transactions according to step (24)(C) with an affiliated mutual fund includes selecting pricing according to a predetermined market at a predetermined time.

31. The method as recited in claim 30, wherein pricing for the transactions according to step (24)(C) with a nonaffiliated mutual fund includes pricing according to an external market price in a market in which such a securities holding is traded.

32. The method as recited in claim 31, wherein transaction preferences include:
(A) a first preference to perform transactions with affiliated mutual funds, and
(B) a second preference to perform transactions with nonaffiliated mutual funds.

33. The method as recited in claim 24, wherein the first and second mutual funds include fund of funds mutual funds.

34. A computer-implemented method for merging first and second mutual funds, comprising the following steps:
(A) selecting the first mutual fund that will be merged into the second mutual fund;
(B) comparing securities holdings of the first mutual fund with a target list of securities holdings of the second mutual fund for matching securities quantities and performing transactions to substantially reposition securities holdings of the first mutual fund to the securities holdings on the target list of the second mutual fund according to predetermined transaction preferences; and
(C) the first mutual fund contributing to the second mutual fund the repositioned securities holdings of the first mutual fund and remaining transferable assets after completion of the transactions at step (34)(B), and the second mutual fund transferring to the first mutual fund the first mutual fund's pro rata ownership share of the second mutual fund based on the first mutual fund's contribution.

35. The method as recited in claim 34, wherein repositioning the securities holdings of the first mutual fund to the target list of the second mutual fund includes
(A) matching in-kind transferable securities holdings of the first mutual fund with the target list of the second mutual fund and performing the transactions at step 34(B) to substantially match such in-kind transferable securities holdings of the first mutual fund; and
(B) converting nontransferable in-kind securities holdings of the first mutual fund to transferable assets.

36. The method as recited in claim 35, wherein transferable assets include cash.

37. The method as recited in claim 36, wherein a total value of the in-kind transferable securities of the first mutual fund, the converted nontransferable in-kind securities holdings, and other transferable assets of the first mutual fund substantially equal to the first mutual fund's total.

38. The method as recited in claim 37, wherein pricing for the transactions according to step (34)(B) includes pricing according to a predetermined pricing methodology.

39. The method as recited in claim 38, wherein pricing for the transactions according to step (34)(B) with an affiliated mutual fund includes selecting pricing according to a predetermined market at a predetermined time.

40. The method as recited in claim 39, wherein pricing for the transactions according to step (34)(B) with a nonaffiliated mutual fund includes pricing according to an external market price in a market in which such a securities holding is traded.
